(19) United States
(12) Patent Application Publication
(10) Pub. No.: US 2022/0205442 A1
(43) Pub. Date: Jun. 30, 2022

(54) METHOD FOR DETERMINING THE POSITION OF THE DIAPHRAGM OF AN ELECTRIC-MOTOR-DRIVEN DIAPHRAGM PUMP

(71) Applicant: ebm-papst St. Georgen GmbH & Co. KG, St. Georgen (DE)

(72) Inventor: David POHL, St. Georgen (DE)

(73) Assignee: ebm-papst St. Georgen GmbH & Co. KG, St. Georgen (DE)

(21) Appl. No.: 17/606,034

(22) PCT Filed: Apr. 29, 2020
(86) PCT No.: PCT/EP2020/061870

§ 371 Date: Oct. 24, 2021

(30) Foreign Application Priority Data
Jul. 1, 2019 (DE) 10 2019 117 729.4

(51) Int. Cl. F04B 43/00; G01B 7/30; F04B 43/04

(52) U.S. Cl. CPC F04B 43/0081; G01B 7/30; F04B 2201/0201; F04B 2203/0207; F04B 43/04

(57) ABSTRACT

A position detection device determines the position of the diaphragm or the drive piston of an electric-motor-driven diaphragm pump, in particular, by detecting the upper and lower reversal point (Po, Pu) in the movement curve of the diaphragm of the diaphragm pump. A diaphragm is actuated by a drive connecting rod to close a conveying chamber with valves provided on an inlet and outlet side. The volume can be changed between a minimum and maximum volume. A rotational movement of an electric motor, with a rotor, is converted into the actuation movement of the drive connecting rod via the effect of the eccentrics. The position detection device detects the load curve of the diaphragm pump during the movement of the diaphragm. An evaluation device determines at least the position of the upper and lower reversal point of the diaphragm from the load curve.

### CROSS-REFERENCE TO RELATED APPLICATIONS

This application is a 371 U.S. National Phase of International Application No. PCT/EP2020/061870, filed Apr. 29, 2020, which claims priority to German Patent Application No. 10 2019 117 729.4, filed Jul. 1, 2019. The entire disclosures of the above applications are incorporated herein by reference.

### FIELD

The present disclosure relates to a method for determining the position of the diaphragm or the drive piston of an electric-motor-driven diaphragm pump, in particular, for detecting the upper and lower reversal points in the movement sequence of the diaphragm of a diaphragm pump.

### BACKGROUND

This section provides background information related to the present disclosure which is not necessarily prior art.

Diaphragm pumps for conveying liquids or gases are generally known from the prior art.

Various designs of diaphragm pumps are available in the prior art. All diaphragm pump designs relate essentially to a machine for conveying liquids or gases, that is particularly resistant to long-term stress and impurities in the conveyed medium. The functional principle of a diaphragm pump is a modification of a known piston pump, however the conveyed medium is separated from the drive unit by a diaphragm. The advantage of this kind of pump is that the separating diaphragm protects the drive unit from harmful influences of the conveyed medium, for example sludge or impurities. This is the particular reason for the ruggedness and low wear of a diaphragm pump that is subjected to long-term stress. This makes such machines well-suited for conveying tasks that have a long operating times and service lives, as is the case for example in the industrial and automotive sectors.

A conventional diaphragm pump has a feed chamber that is closed by a diaphragm and is secured by valves on the inlet and outlet side. The volume of this chamber is changed when a pushing or pulling action is exerted on the diaphragm. This causes a suction or compression event to occur and feeds a fluid in accordance with the valve configuration. The deflection of the diaphragm occurs either hydraulically, pneumatically, mechanically, or electromagnetically.

### SUMMARY

The present disclosure involves an electric-motor-driven diaphragm pump that is mechanically driven by an electric motor. In most cases, such electric-motor-driven diaphragm pumps are driven by an electric motor via a connecting rod, a drive piston and an eccentric.

Diaphragm pumps of this generic type have a high torque fluctuation along a rotation direction of the eccentric relative to the motion of the tappet rod or connecting rod along the eccentric drive. German patent DE 102016125578 A discloses a diaphragm pump that is operated in an electric-motor-driven manner via eccentric elements, that uses a particular drive concept of a reciprocating eccentric drive.

Diaphragm pumps involve the task of knowing the mechanical position of the diaphragm. Thus, the drive piston on the eccentric element achieves an efficient pump operation by the electric motor drive. In addition, it is necessary to detect the reversal points of the diaphragm from the suction phase with an increasing feed volume to the compression phase with a decreasing feed volume. Thus, an excessively early or excessively late valve actuation results in an inefficient operation. Determining the position of the diaphragm and particularly the time of the respective top and bottom dead centers of the diaphragm is also required for basic pump control.

It is an object of the present disclosure is to provide a device and a method, that in a simple and inexpensive way, enables a reliable detection of the position of a diaphragm of an electric-motor-driven diaphragm pump.

The object is attained by the feature combination according to a position detection device for determining the position of a diaphragm or a drive piston of an electric-motor-driven diaphragm pump, in particular for detecting upper and lower reversal point in a movement sequence of the diaphram pump comprising:

the detection device operated in an electric-motor-driven manner via eccentric elements, the diaphram is actuated by a drive connecting rod, to close a feed chamber with valve elements on the inlet and outlet side; the volume can be changed between a minimum and maximum volume through the action of the eccentric elements; a rotary motion of the electric motor with a rotor is converted into an actuating motion of the drive connecting rod; and

the position detection device includes detection means for detecting a load curve of the diaphragm pump during the movement of the diaphragm and has an evaluation device for determining at least the position of the upper and lower reversal point of the diaphragm from the load curve.

According to the disclosure, a position detection device determines the position of the diaphragm or the drive piston of an electric-motor-driven diaphragm pump. It detects the upper and lower reversal point in the movement sequence of the diaphragm of a diaphragm pump operated by an electric motor, via eccentric elements. A diaphragm is actuated by a drive connecting rod, closes a feed chamber, that includes valve elements on the inlet and outlet side. Thus, the volume can be changed between a minimum and maximum volume through the action of the eccentric elements. A rotary motion of an electric motor with a rotor is converted into an actuating motion of the drive connecting rod. The position detection device has a detection means for detecting the load curve of the diaphragm pump during the movement of the diaphragm. It also includes an evaluation device to determine at least the position of the upper and lower reversal point of the diaphragm from the load curve.

For purposes of the present disclosure, the terms upper and lower reversal point are understood to be the positions of the diaphragm where the respective movement direction of the diaphragm in its up and down motion switches into the respective opposite direction. Thus, this respectively reduces or increases the feed volume again in alternating fashion at these points.

In a particularly advantageous embodiment of the disclosure, the detection means are embodied in particular to detect the torque progression curve of the diaphragm pump during a complete up and down motion of the diaphragm. More preferably, it detects during the entire movement of the diaphragm pump so that a continuous position detection of the diaphragm at its reversal points is assured.

It is also advantageous that measuring means detect the position of the rotor of the electric motor. The detection of the rotor position is advantageously performed through the use of multiple position sensors. More preferably, it is through the use of an angle gage to detect the current rotation angle.

In a particularly advantageous embodiment of the disclosure, the position detection device has an evaluation device. The evaluation device cumulatively determines the position of the diaphragm, in particular the upper and lower reversal point of the diaphragm, based on at least the load curve and the relative torque maxima and/or torque minima included therein and based on the position of the rotor that is detected in parallel thereto.

Another aspect of the present disclosure relates to a diaphragm pump that includes a position detection device of the kind described above.

Another innovative aspect of the present disclosure relates to a method for determining the position of the diaphragm or the drive piston of an electric-motor-driven diaphragm pump. In particular, it detects the upper and lower reversal point in the movement sequence of the diaphragm of a diaphragm pump that is operated in an electric-motor-driven manner via eccentric elements. A diaphragm is actuated by a drive connecting rod to close a feed chamber with valve elements on the inlet and outlet side. Thus, the volume can be changed between a minimum and maximum volume through the action of the eccentric elements, a rotary motion of an electric motor, with a rotor converted into an actuating motion of the drive connecting rod. The position determination is carried out based on at least the detection of the load curve and the relative torque maxima and/or torque minima.

In this case, it is advantageous that the method is carried out with a position detection device of the kind described above.

It is also advantageous, if based on the data set of the load curve together with the position of the rotor, an evaluation device cumulatively determines the position of the diaphragm, preferably the upper and lower reversal point of the diaphragm.

In a preferred embodiment where the drive motor is an inverter-fed DC motor, the load curve is determined indirectly from a base-point current measurement of the motor. The measurement of the sum current is taken at the base point or feed point of an inverter bridge of the inverter.

Other advantages/modifications of the disclosure are disclosed in the dependent claims and will be described in greater detail below together with the description of the preferred embodiment of the disclosure based on the FIGURES.

### DRAWINGS

In the drawings:

FIG. 1 is a schematic view of a flowchart, which shows the steps for determining the turning points according to the disclosure.

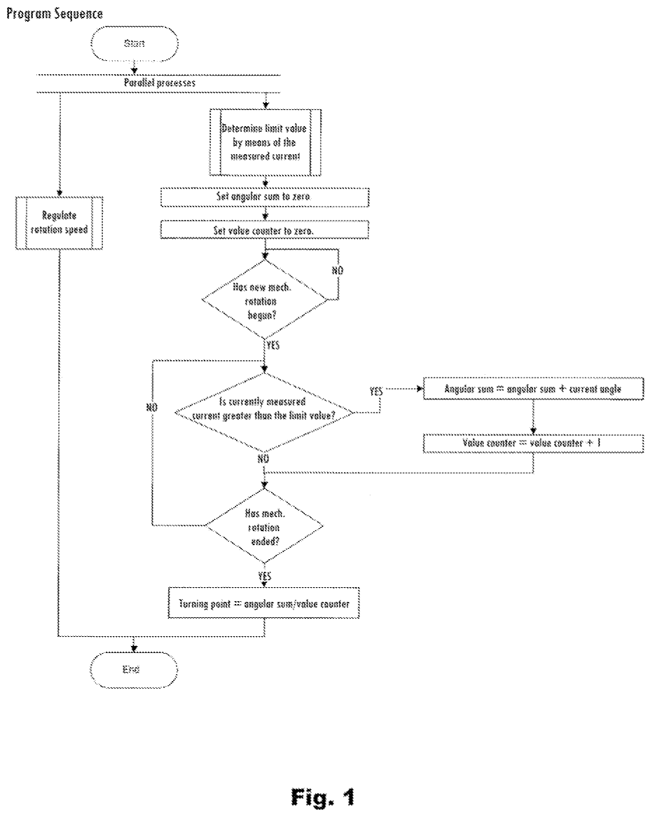

The disclosure will be described in greater detail below based on an exemplary embodiment with reference to FIG. 1.

### DETAILED DESCRIPTION

FIG. 1 shows a flowchart with two processes running in parallel. During the entire process of the determination of the turning points, a speed control of the motor that drives the diaphragm pump is carried out. The right side of the flowchart shows how the detection of the upper and lower reversal point (turning points) is carried out.

The position detection of the reversal points of the diaphragm is carried out based on the rotor position and the motor current (load curve) using position sensors and an angle gage. The limit value of the corresponding motor current is needed. Thus, this changes cyclically with each rotation until it reaches a maximum value.

After the determination of the limit value by means of the measured current, first the stored values for the angular sum and a value counter are reset to zero. A new mechanical rotation can begin or, stated more precisely, a check is performed as to whether a new mechanical rotation has begun. If this is the case, then the evaluation device checks whether the current now being detected is greater than the limit value. If this is the case, then the angular sum is determined by adding the currently determined angle to the stored value of the angular sum and increases the count of the value counter by 1. The limit value used as the basis for comparison is preferably the heavily filtered motor current. The motor current is then compared to this limit value and once the motor current is less than or equal to the limit value, the turning point has been reached. In principle, the angle gage is a memory, which, in each time interval (e.g. 100 ps), is increased by the distance that the rotor has traveled based on its current speed. In principle, angular distances are always added in this case, with these angular distances being expressed in the unit “degrees.”

The process is carried out until the iterative query determines that the mechanical rotation has ended. Then the turning point can be determined from the angular sum and the value counter.

The embodiment of the disclosure is not limited to the preferred exemplary embodiments disclosed above. On the contrary, there are a number of conceivable variants that make use of the presented embodiment, even in fundamentally different embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-10. (canceled)

11. A position detection device for determining the position of a diaphragm or a drive piston of an electric-motor-driven diaphragm pump, in particular for detecting upper and lower reversal point in the movement sequence of a diaphragm of a diaphragm pump comprising:
the detection device operated in an electric-motor-driven manner via eccentric elements, the diaphragm is actuated by a drive connecting rod to close a feed chamber, with valve elements on the inlet and outlet side, the volume can be changed between a minimum and maximum volume through the action of the eccentric elements;
a rotary motion of the electric motor, with a rotor, is converted into an actuating motion of the drive connecting rod; and
the position detection device detecting a load curve of the diaphragm pump during the movement of the diaphragm and has an evaluation device determining at least the position of the upper and lower reversal point of the diaphragm from the load curve.

12. The position detection device according to claim 11, wherein the detection device detects a torque progression curve of the diaphragm pump during a complete up and down motion of the diaphragm.

13. The position detection device according to claim 11, wherein measuring device detects the position of the rotor of the electric motor.

14. The position detection device according to claim 13, wherein the measurement for detecting the rotor position is carried out by multiple position sensors of the rotor of the electric motor, in particular by Hall sensors, and more preferably, by an angle gage for detecting the current rotation angle.

15. The position detection device according to claim 13, wherein an evaluation device cumulatively determines the position of the diaphragm, in particular, the upper and lower reversal point of the diaphragm, the determination is based on at least the load curve and the relative torque maxima and/or torque minima and based on the position of the rotor that is detected in parallel.

16. A diaphragm pump embodied with a position detection device according to claim 11.

17. A method for determining the position of a diaphragm or a drive piston of an electric-motor-driven diaphragm pump, in particular, for detecting an upper and lower reversal point in a movement sequence of the diaphragm of the diaphragm pump that is operated in an electric-motor-driven manner via eccentric elements, comprising:
actuating the diaphragm by a drive connecting rod, closing a feed chamber, with valve elements on the inlet and outlet side;
changing volume between a minimum and maximum volume through action of the eccentric elements;
converting a rotary motion of an electric motor, with a rotor, into the actuating motion of the drive connecting rod; and
carrying out a position determination based on at least the detection of a load curve and a relative torque maxima and/or torque minima.

18. The method according to claim 17 with a position detection device according to claim 11.

19. The method according to claim 17, wherein based on the data set of the load curve together with the position of the rotor, an evaluation device cumulatively determines the position of the diaphragm, preferably the upper and lower reversal point of the diaphragm.

20. The method according to claim 17, wherein the drive motor is an inverter-fed DC motor and the load curve is determined indirectly from a base-point current measurement of the motor, the measurement of the sum current is preferably taken at the base point or feed point of an inverter bridge of the inverter.
